(19) United States
(12) Patent Application Publication
(10) Pub. No.: US 2022/0327380 A1
(43) Pub. Date: Oct. 13, 2022

(54) DETECTION ALGORITHM

(71) Applicant: NOKIA TECHNOLOGIES OY, Espoo (FI)

(72) Inventors: Jakob HOYDIS, Paris (FR); Faycal AIT AOUDIA, Saint Cloud (FR)

(21) Appl. No.: 17/641,648

(22) PCT Filed: Sep. 12, 2019
(86) PCT No.: PCT/EP2019/074323

§ 371 Date: Mar. 9, 2022

(51) Int. Cl. G06N 3/08

(52) U.S. Cl. CPC G06N 3/08

(57) ABSTRACT

An apparatus, method and computer program is described comprising: initialising a plurality of sets of trainable parameters, one set of trainable parameters being initialised for each of a plurality of detection algorithms; obtaining a dataset comprising a plurality of sets of data, each set of data comprising a transmit vector, a receive vector and a channel matrix describing a channel; allocating each of the sets of data to one of a plurality of clusters based on the channel matrix of the respective set of data, wherein each cluster is associated with one of said detection algorithms, wherein the allocation is performed according to a clustering algorithm; and training the trainable parameters of each detection algorithm using the sets of data allocated to the respective cluster.

### FIELD

The present specification relates to detection algorithms, such as multiple-input multiple-output (MIMO) detection algorithms.

### BACKGROUND

Detection algorithms, such as multiple-input multiple-output (MIMO) detection algorithms, having trainable parameters are known. However, there remains scope for further developments in this area.

### SUMMARY

In a first aspect, this specification describes an apparatus comprising: means for initialising (e.g. a random, pseudo-random or arbitrary initialisation) a plurality of sets of trainable parameters, one set of trainable parameters being initialised for each of a plurality of detection algorithms; means for obtaining a dataset (e.g. receiving, collating, retrieving or other obtaining the dataset) comprising a plurality of sets of data, each set of data comprising a transmit vector, a receive vector and a channel matrix describing a channel; means for allocating (e.g. using a neural network) each of the sets of data to one of a plurality of clusters based on the channel matrix of the respective set of data, wherein each duster is associated with one of said detection algorithms, wherein the allocation is performed according to a clustering algorithm; and means for training the trainable parameters of each detection algorithm using the sets of data allocated to the respective cluster. The plurality of sets of trainable parameters may be implemented using neural networks, such that each set of trainable parameters are weights of a neural network. The trainable parameters may be trained by minimising a loss function.

Some embodiments further comprise means for setting a number of clusters in the plurality of clusters.

The allocation may be performed according to the clustering algorithm such that each set of data is allocated to the cluster of the plurality of clusters that it is closest to the channel matrix of said set of data, according to a distance metric. The distance metric may, for example, define a chordal distance between matrices. Each cluster may have a cluster centre, wherein a set of data belongs to the cluster having the cluster centre closest to the channel matrix of said set of data, according to said distance metric.

In some embodiments, the detection algorithms are multiple-input multiple-output (MIMO) detection algorithms.

Each transmit vector may be a constellation point of a transmission scheme (such as QAM).

The means for allocation said sets of data may comprise a neural network.

The plurality of detection algorithms may comprise a plurality of versions of a detection algorithm, each having a different set of parameters.

The clustering algorithm may comprise a K-means algorithm.

The said means may comprise: at least one processor; and at least one memory including computer program code, the at least one memory and the computer program configured, with the at least one processor, to cause the performance of the apparatus.

In a second aspect, this specification describes an apparatus comprising: means for obtaining (e.g. receiving, identifying or retrieving) a receive vector, wherein the receive vector is a vector at an output of a transmission channel, wherein the transmission channel is described by a channel matrix; means for obtaining (e.g. receiving, identifying, retrieving or estimating) said channel matrix or an estimation or approximation of said channel matrix; means for associating the channel matrix with one of a plurality of clusters according to a clustering algorithm; and means for providing the channel matrix and the receive vector as inputs to a detection algorithm of the associated cluster in order to obtain an estimated transmit vector. The detection algorithm may have trained parameters (e.g. trained according to the cluster). The detection algorithm may be a multiple-input multiple-output (MIMO) detection algorithm. The detection algorithm may be implemented using a neural network.

The channel matrix may be associated with the cluster of the plurality of clusters that it is closest to the channel matrix, according to a distance metric. The said distance metric may define a chordal distance between matrices. Each cluster of the plurality of clusters may have a cluster centre, wherein the means for associating the channel matrix associates the channel matrix with the cluster having the duster centre closest to the channel matrix of said set of data, according to said distance metric.

In some embodiments, the estimated transmit vector is a constellation point of a transmission scheme (e.g. QAM).

The clustering algorithm may comprise a K-means algorithm.

The said means may comprise: at least one processor; and at least one memory including computer program code, the at least one memory and the computer program configured, with the at least one processor, to cause the performance of the apparatus.

In a third aspect, this specification describes a method comprising: initialising a plurality of sets of trainable parameters, one set of trainable parameters being initialised for each of a plurality of detection algorithms; obtaining a dataset comprising a plurality of sets of data, each set of data comprising a transmit vector, a receive vector and a channel matrix describing a channel; allocating each of the sets of data to one of a plurality of clusters based on the channel matrix of the respective set of data, wherein each cluster is associated with one of said detection algorithms, wherein the allocation is performed according to a clustering algorithm; and training the trainable parameters of each detection algorithm using the sets of data allocated to the respective cluster.

The plurality of sets of trainable parameters may be implemented using neural networks, such that each set of trainable parameters are weights of a neural network. The trainable parameters may be trained by minimising a loss function.

Some embodiments further comprise setting a number of clusters in the plurality of clusters.

The allocation may be performed according to the clustering algorithm such that each set of data is allocated to the cluster of the plurality of clusters that it is closest to the channel matrix of said set of data, according to a distance metric. The distance metric may, for example, define a chordal distance between matrices. Each cluster may have a cluster centre, wherein a set of data belongs to the cluster having the cluster centre closest to the channel matrix of said set of data, according to said distance metric.

In some embodiments, the detection algorithms are multiple-input multiple-output (MIMO) detection algorithms.

Each transmit vector may be a constellation point of a transmission scheme (such as QAM).

The plurality of detection algorithms may comprise a plurality of versions of a detection algorithm, each having a different set of parameters.

The clustering algorithm may comprise a K-means algorithm.

In a fourth aspect, this specification describes a method comprising: obtaining a receive vector, wherein the receive vector is a vector at an output of a transmission channel, wherein the transmission channel is described by a channel matrix; obtaining said channel matrix or an estimation or approximation of said channel matrix; associating the channel matrix with one of a plurality of dusters according to a clustering algorithm; and providing the channel matrix and the receive vector as inputs to a detection algorithm of the associated cluster in order to obtain an estimated transmit vector. The detection algorithm may have trained parameters (e.g. trained according to the duster). The detection algorithm may be a multiple-input multiple-output (MIMO) detection algorithm. The detection algorithm may be implemented using a neural network.

The channel matrix may be associated with the cluster of the plurality of dusters that it is closest to the channel matrix, according to a distance metric. The said distance metric may define a chordal distance between matrices. Each cluster of the plurality of clusters may have a cluster centre, wherein associating the channel matrix associates the channel matrix with the cluster having the cluster centre closest to the channel matrix of said set of data, according to said distance metric.

In some embodiments, the estimated transmit vector is a constellation point of a transmission scheme (e.g. QAM).

The clustering algorithm may comprise a K-means algorithm.

In a fifth aspect, this specification describes an apparatus configured to perform any method as described with reference to the third or fourth aspects.

In a sixth aspect, this specification describes computer-readable instructions which, when executed by computing apparatus, cause the computing apparatus to perform any method as described with reference to the third or fourth aspects.

In a seventh aspect, this specification describes a work product comprising a look up table or array, created by means of the method as described with reference to the third or fourth aspects.

In an eighth aspect, this specification describes a computer readable medium comprising program instructions stored thereon for performing at least the following: initialising a plurality of sets of trainable parameters, one set of trainable parameters being initialised for each of a plurality of detection algorithms; obtaining a dataset comprising a plurality of sets of data, each set of data comprising a transmit vector, a receive vector and a channel matrix describing a channel; allocating each of the sets of data to one of a plurality of clusters based on the channel matrix of the respective set of data, wherein each duster is associated with one of said detection algorithms, wherein the allocation is performed according to a clustering algorithm; and training the trainable parameters of each detection algorithm using the sets of data allocated to the respective cluster.

In a ninth aspect, this specification describes a computer readable medium comprising program instructions stored thereon for performing at least the following: obtaining a receive vector, wherein the receive vector is a vector at an output of a transmission channel, wherein the transmission channel is described by a channel matrix; obtaining said channel matrix or an estimation or approximation of said channel matrix; associating the channel matrix with one of a plurality of clusters according to a clustering algorithm; and providing the channel matrix and the receive vector as inputs to a detection algorithm of the associated cluster in order to obtain an estimated transmit vector.

In a tenth aspect, this specification describes a computer program comprising instructions for causing an apparatus to perform at least the following: initialising a plurality of sets of trainable parameters, one set of trainable parameters being initialised for each of a plurality of detection algorithms; obtaining a dataset comprising a plurality of sets of data, each set of data comprising a transmit vector, a receive vector and a channel matrix describing a channel; allocating each of the sets of data to one of a plurality of clusters based on the channel matrix of the respective set of data, wherein each cluster is associated with one of said detection algorithms, wherein the allocation is performed according to a clustering algorithm; and training the trainable parameters of each detection algorithm using the sets of data allocated to the respective cluster.

In an eleventh aspect, this specification describes a computer program comprising instructions for causing an apparatus to perform at least the following: obtaining a receive vector, wherein the receive vector is a vector at an output of a transmission channel, wherein the transmission channel is described by a channel matrix; obtaining said channel matrix or an estimation or approximation of said channel matrix; associating the channel matrix with one of a plurality of clusters according to a clustering algorithm; and providing the channel matrix and the receive vector as inputs to a detection algorithm of the associated cluster in order to obtain an estimated transmit vector.

In an twelfth aspect, this specification describes an apparatus comprising: at least one processor; and at least one memory including computer program code which, when executed by the at least one processor, causes the apparatus to: initialise a plurality of sets of trainable parameters, one set of trainable parameters being initialised for each of a plurality of detection algorithms; obtain a dataset comprising a plurality of sets of data, each set of data comprising a transmit vector, a receive vector and a channel matrix describing a channel; allocate each of the sets of data to one of a plurality of clusters based on the channel matrix of the respective set of data, wherein each cluster is associated with one of said detection algorithms, wherein the allocation is performed according to a clustering algorithm; and train the trainable parameters of each detection algorithm using the sets of data allocated to the respective cluster.

In a thirteenth aspect, this specification describes an apparatus comprising: at least one processor; and at least one memory including computer program code which, when executed by the at least one processor, causes the apparatus to: obtain a receive vector, wherein the receive vector is a vector at an output of a transmission channel, wherein the transmission channel is described by a channel matrix; obtain said channel matrix or an estimation or approximation of said channel matrix; associate the channel matrix with one of a plurality of clusters according to a clustering algorithm; and provide the channel matrix and the receive vector as inputs to a detection algorithm of the associated cluster in order to obtain an estimated transmit vector.

In a fourteenth aspect, this specification describes an apparatus comprising: an initialisation module for initialising a plurality of sets of trainable parameters, one set of trainable parameters being initialised for each of a plurality of detection algorithms; a first input for obtaining a dataset comprising a plurality of sets of data, each set of data comprising a transmit vector, a receive vector and a channel matrix describing a channel; a control module (e.g. a neural-network based control module) for allocating each of the sets of data to one of a plurality of clusters based on the channel matrix of the respective set of data, wherein each cluster is associated with one of said detection algorithms, wherein the allocation is performed according to a clustering algorithm; and a trainable module for training the trainable parameters of each detection algorithm using the sets of data allocated to the respective duster.

In a fifteenth aspect, this specification describes an apparatus comprising: a first input for obtaining a receive vector, wherein the receive vector is a vector at an output of a transmission channel, wherein the transmission channel is described by a channel matrix; a second input for obtaining said channel matrix or an estimation or approximation of said channel matrix; a control module for associating the channel matrix with one of a plurality of clusters according to a clustering algorithm; and output module for providing the channel matrix and the receive vector as inputs to a detection algorithm of the associated cluster in order to obtain an estimated transmit vector.

### BRIEF DESCRIPTION OF THE DRAWINGS

Example embodiments will now be described, by way of non-limiting examples, with reference to the following schematic drawings, in which:

FIG. 1 is a block diagram of an example end-to-end communication system;

FIG. 2 is a representation of a modulation scheme used in example embodiments;

FIG. 3 is a flow chart showing an example algorithm;

FIGS. 4 and 5 are block diagrams of system in accordance with example embodiments;

FIG. 6 is a flow chart showing an algorithm in accordance with an example embodiment;

FIG. 7 is a block diagram of a system in accordance with an example embodiment;

FIGS. 8 to 10 are flow charts showing algorithms in accordance with example embodiments;

FIG. 11 shows an example neural network that may be used in example embodiments;

FIG. 12 is a block diagram of a components of a system in accordance with an exemplary embodiment; and

FIGS. 13A and 13B show tangible media, respectively a removable memory unit and a compact disc (CD) storing computer-readable code which when run by a computer perform operations according to embodiments.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

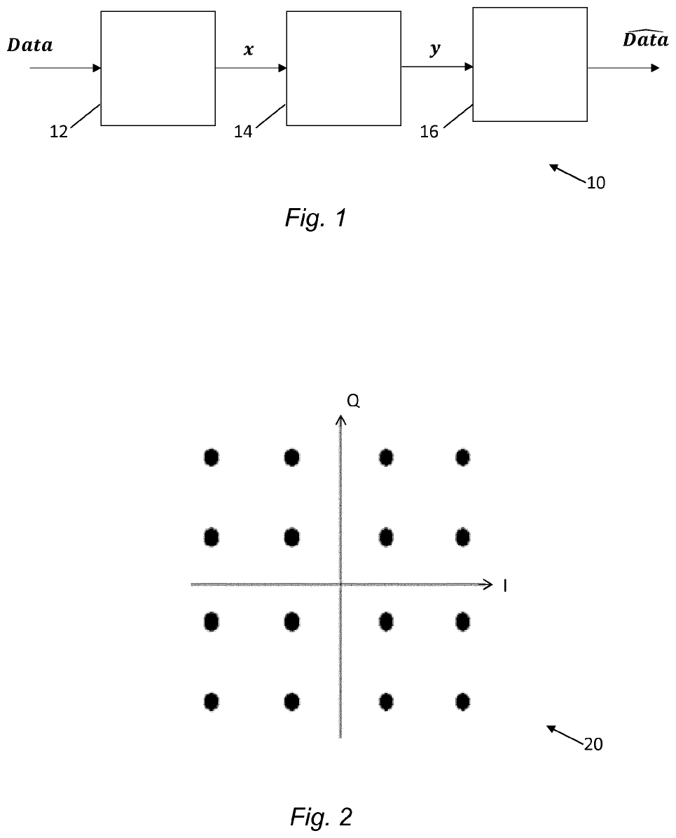

FIG. 1 is a block diagram of an example end-to-end communication system, indicated generally by the reference numeral 10. The system 10 includes a transmitter 12, a channel 14 and a receiver 16. Viewed at a system level, the system 10 converts data received at the input to the transmitter 12 into transmit symbols (x) for transmission over the channel 14 and the receiver 16 generates an estimate of the transmitted data ( [symbol] ) from symbols (y) received from the channel 14.

The transmitter 12 may include a modulator that converts the data symbols into the transmit symbols (x) in accordance with a modulation scheme. The transmit symbols are then transmitted over the channel 14 and received at the receiver 16 as received symbols (y). The receiver may include a demodulator that converts the received symbols (y) into the estimate of the originally transmitted data symbols.

A number of modulation techniques could be used in the implementation of the transmitter 12 and the receiver 16. These include amplitude shift keying (ASK) in which the amplitude of a carrier signal is modified based on a signal being transmitted and phase shift keying (PSK) in which the phase of a carrier signal is modified based on a signal being transmitted. By way of example, quadrature phase shift keying (QPSK) is a form of phase shift keying in which two bits are modulated at once, selecting one of four possible carrier phases shifts (e.g. 0, +90 degree, 180 degrees, −90 degrees). Such carrier phase and amplitudes are often represented as constellation positions in a complex plane.

FIG. 2 is a representation, indicated generally by the reference numeral 20, of a quadrature amplitude modulation (QAM) scheme used in example embodiments. The QAM representation 20 includes 16 points, plotted on in-phase (I) and quadrature (Q) axes. Thus, in the example representation 20, 16 symbols can be modulated in different ways by a modulator (which may form part of the transmitter 12 described above). The skilled person will be aware of many other suitable modulation techniques.

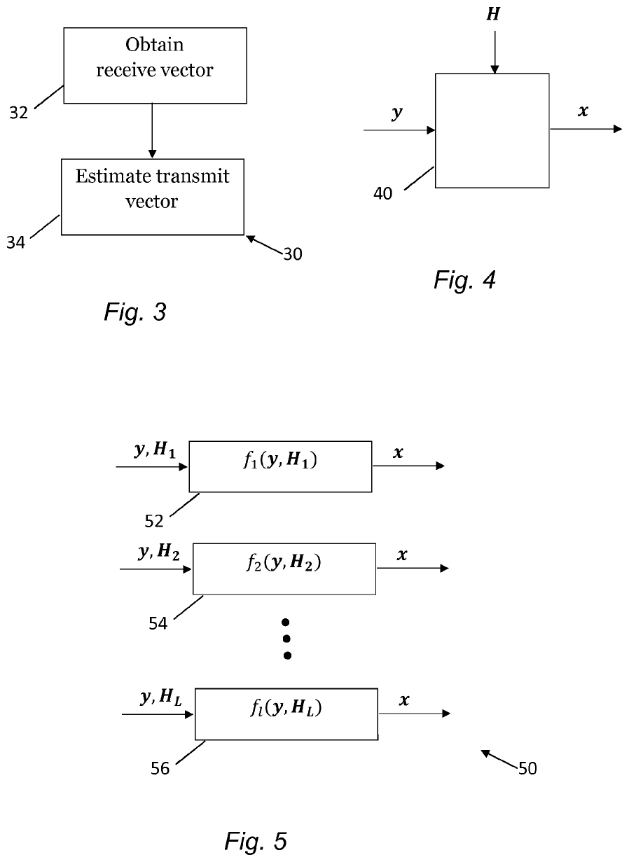

FIG. 3 is a flow chart showing an algorithm, indicated generally by the reference numeral 30. The algorithm 30 starts at operation 32 where a receive vector is obtained. At operation 34, a transmit vector is estimated.

FIG. 4 is a block diagram of system, indicated generally by the reference numeral 40, in accordance with an example embodiment. The system 40 may implement the algorithm 30 described above.

As discussed in detail below, the system 40 receives a channel matrix H and a receive vector y (thereby implementing operation 32 of the algorithm 30) and generates an estimate of the transmit vector x (thereby implementing operation 34 of the algorithm 30). In the context of MIMO, the system 40 may be a MIMO detector that seeks to recover the vector of transmitted symbols x ∈ [symbol] ^{K}, where [symbol] is the constellation such as QAM, from the observation y∈ [symbol] ^{M}, given as

y=Hx+w

where H ∈ [symbol] ^{M×K} is the channel matrix, assumed to be known at the receiver, and w ∈ [symbol] ^{M} is a vector of receiver noise. The best detector is the maximum likelihood (ML) detector solving

$${\hat{x}}_{ML} = arg {min}_{\hat{x} ∈ {ℚ}^{K}} ‖ y - H \hat{x} ‖ .$$

However, solving such an equation is not generally practical.

One implementation option is to use machine-learning principles to train the system 40. For example, a machine learning-based MIMO detection algorithm may train the system 40 using a large dataset consisting of the tuples {(y₁, Hᵢ), xᵢ} for i=1 . . . , N, where (yᵢ, Hᵢ) is the input to the algorithm and xᵢ is the targeted output (label) for example i. This means that a single algorithm may be used to perform detection for any possible realization of the channel matrix H. However, this approach tends to lead to trainable algorithms that tend to be very complex or deliver unsatisfactory performance when the distribution of the channel matrices is very rich, as can be expected in a real-world deployment.

FIG. 5 is a block diagram of system, indicated generally by the reference numeral 50, in accordance with an example embodiment. As discussed further below, the system 50 provides a detection algorithm (such as a MIMO detection algorithm) with trainable parameters θ (e.g., the weights of a neural network). However, unlike the system 40 described above, L different versions of this algorithm are trained on different parts of the dataset, resulting in L different sets of trainable parameters θₗ, l=1 . . . , L. Thus, the system 50 comprises a first detection algorithm 52, a second detection algorithm 54 and an L-th detection algorithm 56. Thus, the plurality of detection algorithms 52 to 56 may comprise a plurality of versions of a detection algorithm, each having a different set of parameters.

The dataset for training the system 50 is partitioned into L parts by clustering the corresponding channel matrices Hᵢ into L clusters according to some metric (such as a distance metric), as discussed further below. Thus, each of the different versions of the algorithm is optimized for a different sub-set of channel realizations. This makes the detection task easier, so that the performance is improved, and the detection algorithm can be made less complex.

In the system 50, the first detection algorithm 52 is trained to provide a function ƒ₁(y, H₁) and is trained using the data corresponding to the channel matrices H₁. Similarly, the second detection algorithm 54 is trained to provide a function ƒ₂(y, H₂) and is trained using the data corresponding to the channel matrices H₂ and the L-th detection algorithm 56 is trained to provide a function ƒ_{L}(y, H_{L}) and is trained using the data corresponding to the channel matrices H_{L}.

At runtime, upon estimating a channel matrix H, the best set of parameters θ to configure the detection algorithm is selected by finding the duster to which H it belongs.

Thus, if suitable clustering can be implemented, a detection algorithm ƒ_{θ}(y, H) can be generated that is parametrized by the parameter vector θ. The output of the algorithm is either a valid vector of transmitted symbols \hat{x} ∈ [symbol] ^{K} or a probability distribution p(\hat{x}|y, H) from which a hard decision can be obtained according to

$$\hat{x} = arg {max}_{\hat{x} ∈ {ℚ}^{K}} p ( \hat{x} \vert y , H ) .$$

The system 50 seeks to optimize the parameter vector θ for L>1 different classes of channel matrices H. Thus, rather than optimizing θ so that the detection algorithm works well for all channel matrices (as described above with reference to FIGS. 3 and 4), the detection problem can be made simpler by restricting the optimization to a sub-set of all possible channel matrices (as described with reference to FIG. 5). This approach can lead to both better performance and reduced complexity.

As discussed further below, an implementation of the system 50 includes:
A clustering algorithm that allows us to determine to which out of L classes a channel matrix H belongs.
A training algorithm that provides us with L different parameter vectors θₗ, l=1 . . . , L.

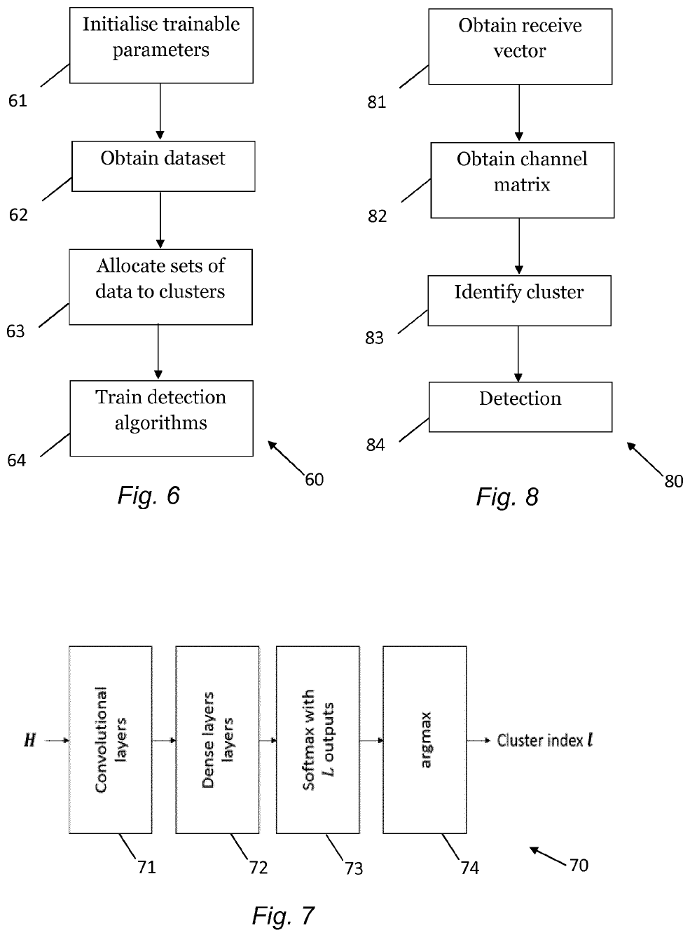

FIG. 6 is a flow chart showing an algorithm, indicated generally by the reference numeral 60, in accordance with an example embodiment. The algorithm 60 is an example algorithm by which the system 50 may be trained.

The algorithm 60 starts at operation 61, where trainable parameters for the algorithm 60 are initialised (for example, in accordance with a random or an arbitrary initialisation). A plurality of sets of trainable parameters may be initialised, with one set of trainable parameters being initialised for each of a plurality of detection algorithms (such as the algorithms 52, 54 and 56 of the system 50).

At operation 62, a dataset is obtained (e.g. by receiving, collating, retrieving or other obtaining such a dataset) for training the system 50. The dataset comprises a plurality of sets of data, each set of data comprising a transmit vector, a receive vector and a channel matrix describing a channel. As described above, the receive vector (y) may be given by y=Hx+w, where H is the channel matrix and w is noise. The transmit vectors may be constellation points of a transmission scheme (such as QAM).

At operation 63, each of the sets of data obtained in operation 62 is allocated to one of a plurality of clusters based on the channel matrix of the respective set of data. Each cluster may be associated with one of said detection algorithms 52, 54 and 56 of the system 50, wherein the allocation is performed according to a clustering algorithm. The operation 63 may include setting or defining how many clusters are to be used in a particular example implementation.

A number of clustering algorithms are known and may be used in an implementation of the operation 63. One option is the widely known K-Means algorithm, but other options (such as a random forest algorithm) may be used and suitable options will be apparent to those of ordinary skill in the art.

A first step of an example K-Means algorithm is to define a distance metric d (A, B) between two matrices A and B and to compute the mean value of multiple matrices. For example, one can use the chordal distance d_{C}(A, B)=∥AA^{H}−BB^{H}∥_{F}² between two matrices and define the mean of M (tall) unitary matrices U₁, . . . , U_{M} as

$$\overline{U} = {eig}_{p} [ \frac{1}{M} {\sum }_{i = 1}^{M} {U}_{i} {U}_{i}^{H} ] ,$$

where eigₚ (A) denotes the matrix formed by the p dominant eigenvectors of A. Using this distance metric and mean, one can apply the standard K− means algorithm to the dominant eigenspaces of the set of channel matrices Hᵢ, i=1 . . . , N.

The output of such an approach is a set of L cluster centers H̅ₗ, l=1 . . . , L. A channel matrix H belongs to cluster l if

$$l = arg {min}_{k = 1 , … , L} d ( H , {\overline{H}}_{k} ) ,$$

i.e., if it is closest to cluster center l as measured by d.

At operation 64, each of the detection algorithms (such as the algorithms 52, 54 and 56) is trained using the sets of data allocated to the respective cluster in the operation 63. As discussed in detail below, the training operation 64 may be implemented by minimising a loss function. Thus, each detection algorithm is trained using the channel matrices, transmit vector and receive vectors of the datasets associated with that detection algorithm (according to the clustering algorithm). Thus, each set of trainable parameters (as initialised in the operation 61) is trained using part of the dataset obtained in operation 62, in accordance with the clustering performed in operation 63.

The clustering operation 63 may be implemented in a number of different ways, one option being the use of a neural network to perform the allocation. In one embodiment, the classification of channel matrices could also be performed by a neural network.

By way of example, FIG. 7 is a block diagram of system, indicated generally by the reference numeral 70, in accordance with an example embodiment. The system 70 may be used to implement the operation 63 described above. The system 70 is a convolutional neural network-based classifier with L classes. The system 70 comprises a convolutional layers module 71, dense layers module 72, a softmax output activation module 73 and an argmax module 74. The system 70 receives the channel matrix H and provides a duster index 1.

FIG. 8 is a flow chart showing an algorithm, indicated generally by the reference numeral 80, in accordance with an example embodiment.

At operation 81, a receive vector is obtained (e.g. received, identified, retrieved or otherwise obtained), wherein the receive vector is a vector at an output of a transmission channel, wherein the transmission channel is described by a channel matrix.

At operation 82, a channel matrix or an estimation or approximation of said channel matrix is obtained (e.g. received, identified, retrieved or otherwise obtained).

At operation 83, an algorithm is used to associate the channel matrix with one of a plurality of clusters. The channel matrix may be associated with the cluster of the plurality of clusters that it is closest to the channel matrix, according to a distance metric (e.g. a chordal distance between matrices). Each cluster of the plurality of clusters may have a duster centre, wherein the means for associating the channel matrix associated the channel matrix with the cluster having the cluster centre closest to the channel matrix of said set of data, according to said distance metric.

Finally, at operation 84, the receive vector and the channel matrix obtained in operations 81 and 82 are provided as inputs to a detection algorithm (such as a MIMO detection algorithm) of the associated cluster in order to obtain an estimated transmit vector (which transmit vector may, for example, be a constellation point of a transmission scheme, such as QAM, as discussed above). The detection algorithm may be one of the algorithms 52, 54 and 56 trained using the algorithm 60 described above. The detection algorithm may be implemented using a neural network.

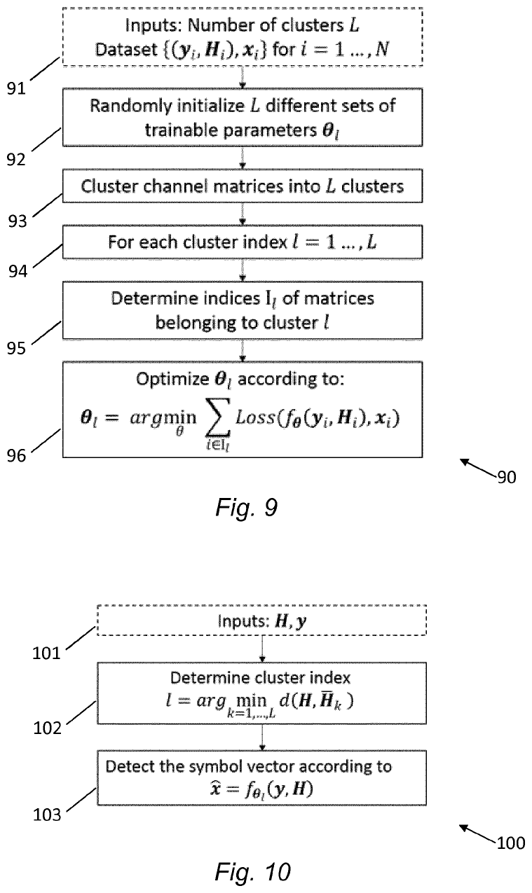

FIG. 9 is a flow chart showing an algorithm, indicated generally by the reference numeral 90, in accordance with an example embodiment. The algorithm 90 has a number of similarities with the algorithm 60 described above.

At operation 91, a number of clusters L>1 is chosen and a dataset {(yᵢ, Hᵢ), xᵢ} for i=1 . . . , N is obtained. The number of dusters may be predefined, may be a user-definable parameters, or may be set in some other way. For example, an algorithm (such as a neural network-based algorithm) may be provided that seeks to define an optimum number of dusters for a particular set of data.

At operation 92, L different sets of trainable parameters θₗ, l=1 . . . , L are randomly initialised.

At operation 93, the channel matrices Hᵢ are clustered into L clusters according to a distance metric d and a clustering algorithm. The outcome of this step is a set of L cluster centers H̅ₗ, l=1 . . . , L. A channel matrix H belongs to cluster l if

$$l = arg {min}_{k = 1 , … , L} d ( H , {\overline{H}}_{k} ) ,$$

i.e., if it is closest to cluster center l as measured by d.

At operation 94, for l=1 . . . , L, all matrices Hᵢ in the dataset belonging to cluster l are determined. These are denoted by the set of indices I. The allocation of sets of data to clusters may be performed according to a clustering algorithm (such as a K-Means clustering algorithm). As described above, each set of data may be allocated to the cluster of the plurality of clusters that it is closest to the channel matrix of said set of data, according to a distance metric. In one example implementation, each cluster has a cluster centre, wherein a set of data belongs to the cluster having the cluster centre closest to the channel matrix of said set of data, according to said distance metric.

At operation 95, the trainable parameters θₗ are optimised according to:

$${θ}_{l} = arg {min}_{θ} {\sum }_{i ∈ {I}_{l}} Loss ( {f}_{θ} ( {y}_{i} , {H}_{i} ) , {x}_{i} )$$

where Loss is a loss function that measures the error between the output of the detection algorithm and the desired target output.

In many cases, the optimization in operation 95 cannot be carried out exactly, but one can compute an approximation, e.g., through gradient descent or a variant thereof. The loss function could be, e.g., the mean-squared error, the categorical cross-entropy, symbol error rate.

In an example embodiment, the clustering operation (operation 93) is replaced by training a neural network to classify the channel matrices.

FIG. 10 is a flow chart showing an algorithm, indicated generally by the reference numeral 100, in accordance with an example embodiment. The algorithm 100 has a number of similarities with the algorithm 80 described above.

At operation 101, a channel matrix H is obtained, together with a channel output y.

At operation 102, a cluster index l is determined (so that the cluster index to which the obtained channel matrix H belongs is determined). This is given by:

$$l = arg {min}_{k = 1 , … , L} d ( H , {\overline{H}}_{k} ) .$$

At operation 103, the symbol vector is detected according to: \hat{x}=ƒ_{θ}_{ₗ}(y, H)

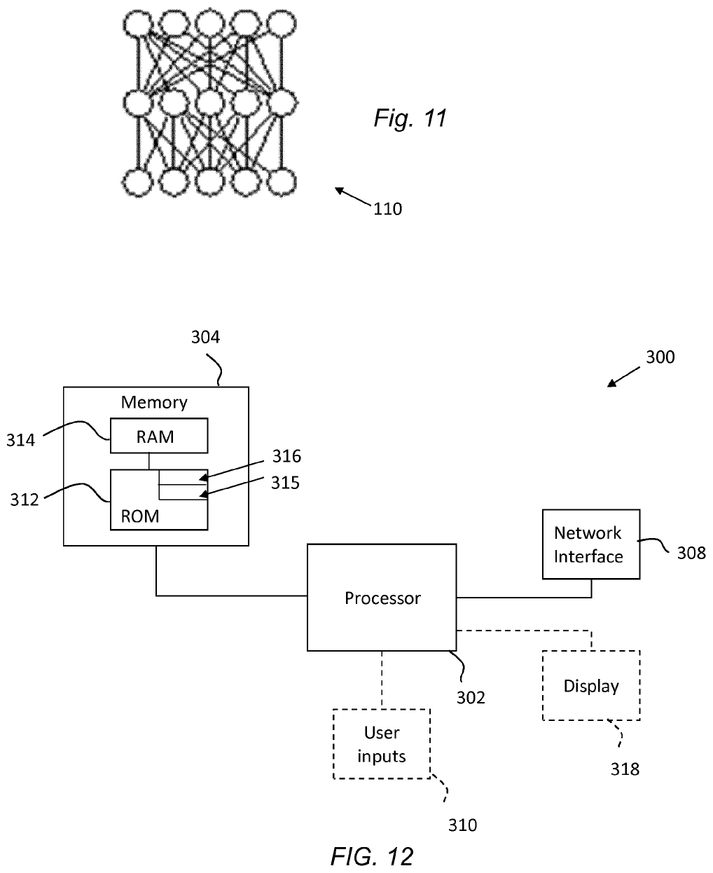

Neural network technology may be used in a number of implementations described herein. FIG. 11 shows an example neural network 110 that may be used in one or more example embodiments. The neural network 110 comprises a plurality of interconnected nodes arranged in a plurality of layers. A neural network, such as the network 110, can be trained by adjusting the connections between nodes and the relative weights of those connections. As noted above, the transmitter and receiver algorithms may be implemented using one of more neural networks, such as a neural network having the form of the neural network 110.

For completeness, FIG. 12 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 30, 60, 80, 90 and 100 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

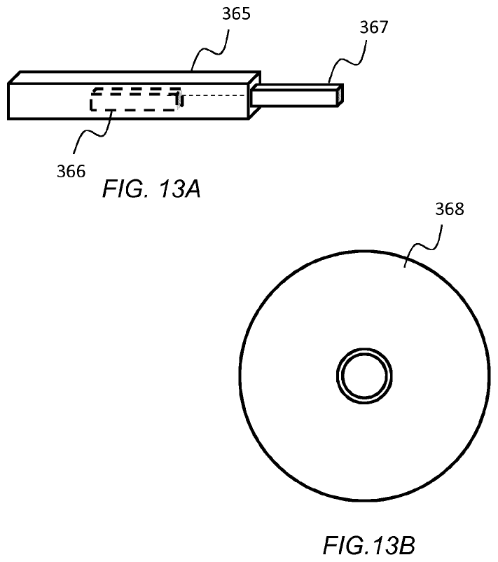

FIGS. 13A and 13B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 3, 6 and 8 to 10 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus, comprising:
at least one processor; and
at least one memory including computer program code, the at least one memory and computer program code being configured, with the at least one processor, to cause the apparatus to perform:
initializing a plurality of sets of trainable parameters, one set of trainable parameters being initialized for each of a plurality of detection algorithms;
obtaining a dataset comprising a plurality of sets of data, each set of data comprising a transmit vector, a receive vector and a channel matrix describing a channel;
allocating each of the sets of data to one of a plurality of clusters based on the channel matrix of the respective set of data, wherein each cluster is associated with one of said detection algorithms, wherein the allocation is performed according to a clustering algorithm; and
training the trainable parameters of each detection algorithm using the sets of data allocated to the respective cluster.

2. The apparatus as claimed in claim 1, wherein the at least one memory and computer program code are further configured, with the at least one processor, to cause the apparatus to perform setting a number of clusters in the plurality of clusters.

3. The apparatus as claimed in claim 1, wherein the allocation is performed according to the clustering algorithm such that each set of data is allocated to the cluster of the plurality of clusters that it is closest to the channel matrix of said set of data, according to a distance metric.

4. The apparatus as claimed in claim 3, wherein each cluster has a cluster center, wherein a set of data belongs to the cluster having the cluster center closest to the channel matrix of said set of data, according to said distance metric.

5. The apparatus as claimed in claim 1, wherein the detection algorithms comprise multiple-input multiple-output (MIMO) detection algorithms.

6. The apparatus as claimed in claim 1, wherein each transmit vector comprises a constellation point of a transmission scheme.

7. The apparatus as claimed in claim 1, wherein the trainable parameters are trained by minimizing a loss function.

8. The apparatus as claimed in any one of the claim 1, wherein the allocation of said sets of data is performed in conjunction with a neural network.

9. The apparatus as claimed in claim 1, wherein the plurality of detection algorithms comprise a plurality of versions of a detection algorithm, each having a different set of parameters.

10. An apparatus, comprising:
at least one processor; and
at least one memory including computer program code, the at lest one memory and computer program code being configured, with the at least one processor, to cause the apparatus to perform:
obtaining a receive vector, wherein the receive vector is a vector at an output of a transmission channel, wherein the transmission channel is described by a channel matrix;
obtaining said channel matrix or an estimation or approximation of said channel matrix;
associating the channel matrix with one of a plurality of clusters according to a clustering algorithm; and
providing the channel matrix and the receive vector as inputs to a detection algorithm of the associated cluster in order to obtain an estimated transmit vector.

11. The apparatus as claimed in claim 10, wherein the channel matrix is associated with the cluster of the plurality of clusters that it is closest to the channel matrix, according to a distance metric.

12. The apparatus as claimed in claim 11, wherein each cluster of the plurality of clusters has a cluster center, and wherein the associating the channel matrix associates the channel matrix with the cluster having the cluster center closest to the channel matrix of said set of data, according to said distance metric.

13. The apparatus as claimed in claim 10, wherein the detection algorithm is implemented using a neural network.

14. The apparatus as claimed in claim 10, wherein the estimated transmit vector is a constellation point of a transmission scheme.

15. The apparatus as claimed in claim 10, wherein the clustering algorithm comprises a K-means algorithm.

16. A method, comprising:
initializing a plurality of sets of trainable parameters, one set of trainable parameters being initialized for each of a plurality of detection algorithms;
obtaining a dataset comprising a plurality of sets of data, each set of data comprising a transmit vector, a receive vector and a channel matrix describing a channel;
allocating each of the sets of data to one of a plurality of clusters based on the channel matrix of the respective set of data, wherein each cluster is associated with one of said detection algorithms, wherein the allocation is performed according to a clustering algorithm; and
training the trainable parameters of each detection algorithm using the sets of data allocated to the respective cluster.

17. A method, comprising:
obtaining a receive vector, wherein the receive vector is a vector at an output of a transmission channel, wherein the transmission channel is described by a channel matrix;
obtaining said channel matrix or an estimation or approximation of said channel matrix;
associating the channel matrix with one of a plurality of clusters according to a clustering algorithm; and
providing the channel matrix and the receive vector as inputs to a detection algorithm of the associated cluster in order to obtain an estimated transmit vector.

18. (canceled)

19. A computer program embodied on a non-transitory computer medium, said computer program comprising instructions for causing an apparatus to perform at least:
initializing a plurality of sets of trainable parameters, one set of trainable parameters being initialized for each of a plurality of detection algorithms;
obtaining a dataset comprising a plurality of sets of data, each set of data comprising a transmit vector, a receive vector and a channel matrix describing a channel;
allocating each of the sets of data to one of a plurality of clusters based on the channel matrix of the respective set of data, wherein each cluster is associated with one of said detection algorithms, wherein the allocation is performed according to a clustering algorithm; and
training the trainable parameters of each detection algorithm using the sets of data allocated to the respective cluster.

20. A computer program embodied on a non-transitory computer-readable medium, said computer program comprising instructions for causing an apparatus to perform at least the following:
obtaining a receive vector, wherein the receive vector is a vector at an output of a transmission channel, wherein the transmission channel is described by a channel matrix;
obtaining said channel matrix or an estimation or approximation of said channel matrix;
associating the channel matrix with one of a plurality of clusters according to a clustering algorithm; and
providing the channel matrix and the receive vector as inputs to a detection algorithm of the associated cluster in order to obtain an estimated transmit vector.
